(19) United States
(12) Patent Application Publication
(10) Pub. No.: US 2007/0006000 A1
(43) Pub. Date: Jan. 4, 2007

(54) Using fine-grained power management of physical system memory to improve system sleep

(76) Inventors: Sandeep Jain, Milpitas, CA (US); Paul Diefenbaugh, Portland, OR (US); James P. Kardach, Saratoga, CA (US); Ramkumar Vankatachary, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/174,375

(22) Filed: Jun. 30, 2005

(51) Int. Cl. G06F 1/00

(52) U.S. Cl. 713/300

(57) ABSTRACT

The methods for fine-grained power management of physical system memory allow portions of the system volatile memory to be independently power managed. The system volatile memory may be partitioned into a plurality of power management units (PMUs). Each PMU may have a pre-determined size or a variable size, which may be less than the size of a memory chip. Each PMU may be placed in a different memory state and independently power managed according to the memory state. At opportune times during the system active state, a fractional potion of the system volatile memory is shadowed into the system nonvolatile memory. Active data in the system volatile memory is rearranged prior to entering a power-saving mode and the PMUs containing the shadowed data may be powered off. Thus, power efficiency of the system volatile memory is improved.

### BACKGROUND

1. Field of the Invention

Embodiments of the invention relate to power management for memory devices and system sleep states to improve system sleep. Specifically, embodiments of the invention relate to fine-grained power management of physical system memory.

2. Background

Some system devices, such as memory, may operate in various power consumption modes such as active, standby, and off. These power consumption modes of these devices coincide with and are globally controlled by the power consumption mode of the overall system. If the entire system is off, then all of the components of the system such as disk drives, processors, and volatile memories are also powered off. If the entire system is in a standby mode, then most of the components in the system are in a reduced power consumption mode. If the entire system is in an active mode, then all of the components in the system are in a fully powered up state.

### BRIEF DESCRIPTION OF THE DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 shows a state diagram for a computing system;

FIG. 2 shows an embodiment of a memory system including a memory manager for managing the power of physical system memory;

FIG. 3 shows a state diagram for the system memory of FIG. 2;

FIG. 4 shows a timing diagram for completely shutting off a portion of the system memory;

FIG. 5 is a flowchart showing the transition of the system memory into a self-refreshed state (S3) and a hibernate state (S4);

FIG. 6 shows shadowing read-only pages of the system memory into a paging file;

FIG. 7 shows shadowing stale pages of the system memory into the paging file;

FIG. 8 shows compressing and reordering active pages at the entry of the S3 state;

FIG. 9 shows partially restoring the shadowed pages when exiting the S3 state;

FIG. 10 shows writing active pages into a hibernate file at the entry of the S4 state; and

FIG. 11 shows partially restoring the shadowed pages and the active pages when exiting the S4 state.

### DETAILED DESCRIPTION

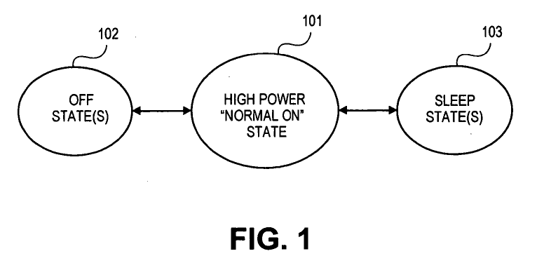

FIG. 1 shows a state diagram for a computing system. An embodiment of the operating states observed in FIG. 1 may be found in the Advanced Configuration and Power Interface (ACPI) Specification, Revision 2.0a dated Mar. 31, 2002 (and published by Compaq Computer Corporation, Intel Corporation, Microsoft Corporation, Phoenix Technologies Ltd., and Toshiba Corporation). Although the ACPI specification is recognized as describing a large number of existing computing systems, it should be recognized that large numbers of computing systems that do not conform to the ACPI specification can still conform to the operating state configuration observed in FIG. 1.

According to the depiction of FIG. 1, a first state 101, referred to as the “normal on” state 101, is the normal operating state of the computing system when the computing system including physical system memory is actively powered for access by a user. Within the ACPI specification, the “normal on” state 101 is referred to as the “G0” state. A second state 102 refers to any of one or more states where the computing system is recognized as being “off”. The ACPI specification recognizes two such states: a hardware based off state and a software based off state. In the hardware based off state, power has been removed from the entire computing system. In the software based off state, power is provided to the computing system but the BIOS and operating system (OS) have to be reloaded from scratch without reference to the stored context of a previously operating environment. The ACPI specification refers to the hardware based off state as the “G3” state and the software based off state as the “G2” state.

A third state 103 refers to any of one or more states where the computing system is recognized as “sleep.” For sleep states, the operating environment of a system within the “normal on” state 101 (e.g., the state and data of various software routines) are saved prior to the CPU of the computing system enters into a lower power consumption state. The sleep state(s) 103 are aimed at saving power consumed by the CPU and the system memory over a lull period in the continuous use of the computing system. That is, for example, if a user is using a computing system in the normal on state 101 (e.g., typing a document) and then becomes distracted so as to temporarily refrain from such use (e.g., to answer a telephone call)—the computing system can automatically transition from the normal on state 101 to a sleep state 102 to reduce power consumption.

Here, the software operating environment of the computing system (e.g., including the document being written), which is also referred to as “context” or “the context,” is saved beforehand. As a consequence, when the user returns to use the computing system after the distraction is complete, the computing system can automatically present the user with the environment that existed when the distraction arose (by recalling the saved context) as part of the transition back to the normal state 101 from the sleep state 103. The ACPI specification recognizes a collection of different sleep states (notably the “S1”, “S2”, “S3” and “S4” states) each having its own respective balance between power savings and delay when returning to the “normal on” state 101. The S1, S2 and S3 states are recognized as being various flavors of “standby” and the S4 state is a “hibernate” state. In the S3 state, memory logic of the system memory is self-refreshed to maintain the contents alive. In the S4 state, power is removed from the system memory and the contents stored in the memory logic is lost. Various groups have adopted schemes to streamline the sleep state suspend/resume process, e.g., the Microsoft® Windows XP and the forthcoming Windows longhorn release.

Generally, when the prior art computing system enters into the S1, S2, or S3 state power is uniformly applied to the entire system memory. As such, unused portion of the memory consumes power unnecessarily when merely a small portion of the memory is being actively used. Thus, the power efficiency of the system is decreased.

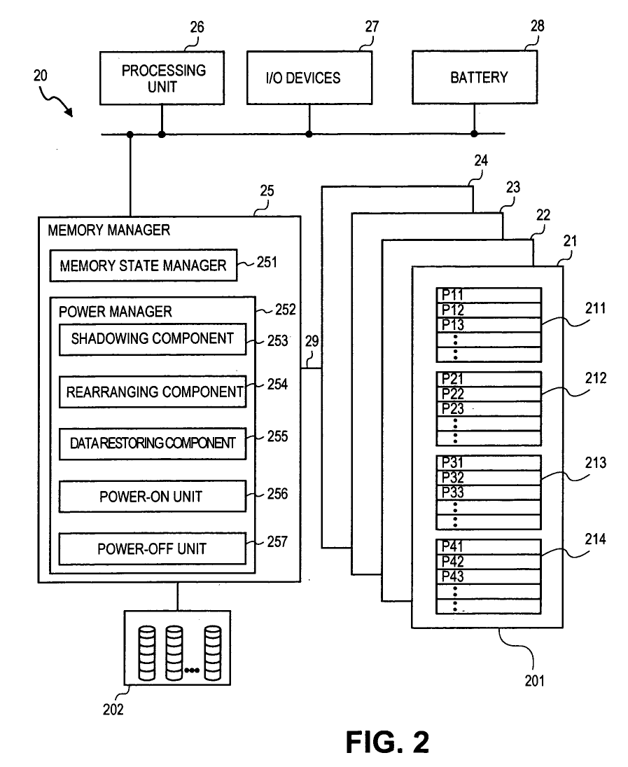

FIG. 2 shows an embodiment of a computing system 20 including a processing unit 26, I/O devices 27, a battery 28, physical system memory 201 (e.g., dual in-line memory modules (DIMM) or any system volatile memory), and secondary memory 202 (e.g., disks, flash memory, or any non-volatile memory devices). In one embodiment, the system memory 201 includes four memory ranks (21, 22, 23, 24), which have substantially the same function and structure. Thus, for the purpose of simplifying the discussion, merely memory rank 21 will be described below. The memory rank 21 may include four memory chips 211, 212, 213, and 214 which are based on dynamic random access memory (DRAM) or synchronous DRAM (SDRAM) technology, e.g., Intel® Double Data Rate (DDR) memory chips. The memory rank 21 is coupled to an intelligent memory manager 25 via a memory bus 29.

In one embodiment, the memory manager 25 includes a memory state manager 251 and a power manager 252. The power manager further includes a shadowing component 253, a rearranging component 254, a data restoring component 255, a power-on unit 256, and a power off unit 257. The memory manager 25 adopts a fine-grained power management (FGPM) policy to individually manage the provision of power to power management units (PMUs) in each memory rank 21. In alternative embodiments, the FGPM may be implemented in hardware, firmware, or software residing on any machine-readable media including recordable/non-recordable media, magnetic or optical storage media, or other similar media. The PMU may be a memory chip, a subdivision of a memory rank of a pre-determined size, a block of memory of a variable size, or any partition of the system memory 201. The FGPM policy allows fine-grained power management of the system memory 201 such that the unused memory portion may receive low or no power to reduce power consumption of the memory at run time (e.g., the G0 state). Further, the FGPM policy provides a power-efficient method for the system memory 201 in connection with memory state transitions. The FGPM has the additional benefits of improving the entry into and exit from the S3 and S4 states.

The memory state manager 251 chooses a PMU when specifying a memory state for the PMU. The power manager 252 issues a power management command to the specified PMU according to the FGPM policy. In one embodiment, each of the PMUs has a uniform and pre-determined size called a “sub-rank”. Each PMU is identified by a rank number and a sub-rank number (e.g., sub-rank0, sub-rank1, sub-rank2, etc.). In an alternative embodiment, the PMUs have variable sizes. The memory state manager 251 specifies a start address and an end address of a PMU when commanding the PMU to enter one of the memory states to be described below. Following the specification of memory states for a PMU, the power manager 252 may issue a power management command to manage the power of the PMU.

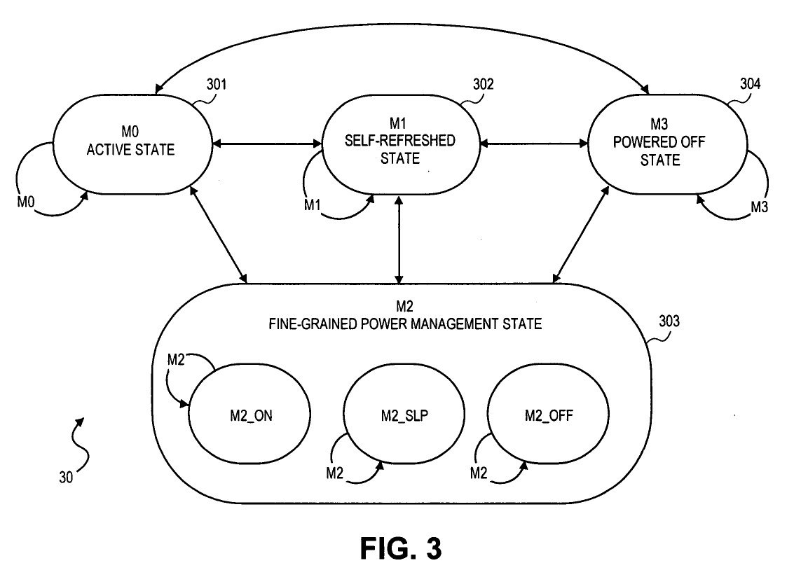

FIG. 3 shows a state diagram 30 of the system memory 201 including four memory states. These memory states describe the activities of the system memory 201 and should be distinguished from the states of FIG. 1 which describe the activities of a computing system (e.g., the computing system 20). A first state 301 (referred to as the “M0 state”) is the active state in which high power is provided to the system memory 201 to support read and write activities. The provision of power in M0 may be rank-based. For example, memory rank 21 may be on while memory ranks 22, 23, and 24 may be powered off to reduce power consumption. A second state 302 (referred to as the “M1 state”) is the self-refreshed state in which low power is provided to the system memory 201 to maintain the contents of the memory. The S1, S2, and the S3 states under the ACPI specification currently utilize the M1 state. A third state 303 (referred to as the “M2 state”) is a fine-grained power management state. In the M2 state, some portion of the system memory 201 may be on (referred to as the “M2_ON” state), some portion of the system memory may be self-refreshed (referred to as the “M2_SLP” state), and some other portion of the system memory may be powered off (referred to as the “M2_OFF” state). A fourth state 304 (referred to as the “M3 state”) is a powered off state in which the system memory 201 shuts down and the contents stored therein are lost.

The M0, M1, M2, and M3 states (i.e., the Mx states) are rank-based capable; that is, each memory rank may be independently placed into any one of the memory states. Additionally, the memory rank 21 may be further partitioned where each of the partitions is placed in any of the M2 states. The Mx states may be supported by any system platform that routes power independently to each memory rank 21 or each PMU. In current systems, the implementation of the Mx states may be limited by the routing of a single power rail to all memory ranks or the use of non-intelligent memory management policies.

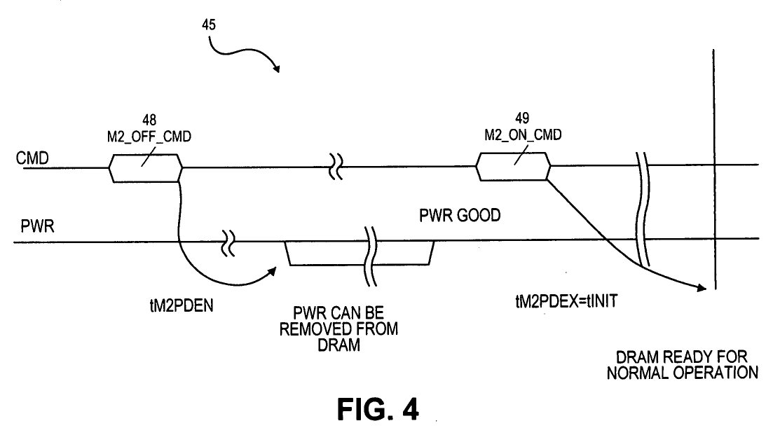

When a portion of system memory 201 enters the M2_OFF state, the contents of the memory portion are lost and power consumption is significantly lower than the M2_SLP state. According to the specific implementation of physical memory and/or configuration specified by the memory manager 25, some or all of the memory circuitry are turned off or disabled, including clocks, internal voltage regulators (VR), delay-locked loops (DLL), and all other logic and components. FIG. 4 shows a timing diagram 45 of a M2_OFF transition command (e.g., M2_OFF_CMD_{—}48) issued by the power manager 252. The M2_OFF_CMD command 48 triggers a command sequence to completely shut off the power of the memory portion. The command sequence may include the operations to, for example: wait for pending operations to finish, precharge all memory ranks, disable the DLL, place the memory portion in precharge power down, and remove external clocks connecting to the memory portion. To recover from the complete power shut-off, the power manager 252 may issue an M2_ON transition command (e.g., M2_ON_CMD 49) to reinitialize the memory portion.

Referring back to FIG. 2, in one embodiment, the memory rank 21 is partitioned into a plurality of pages (e.g., p11, p12, p13, etc.). A page is a block of memory, typically 4 kilobytes or less in size, allocated to the system, applications, or programs. A page typically corresponds to the amount of information requested by OS on a typical request. Each of the pages may store readable and writable (R/W) date or read-only data (e.g., key operating system kernel code and structures). Some of the R/W pages and read-only pages are non-paged; that is, these pages normally are not moved outside the physical system memory 201 for the purpose of page swapping in a virtual memory scheme. Non-paged data typically includes portions of software (e.g. OS kernel, drivers) used to handle interrupt service routines and other code and data that are accessible without the possibility of paging from the secondary memory 202.

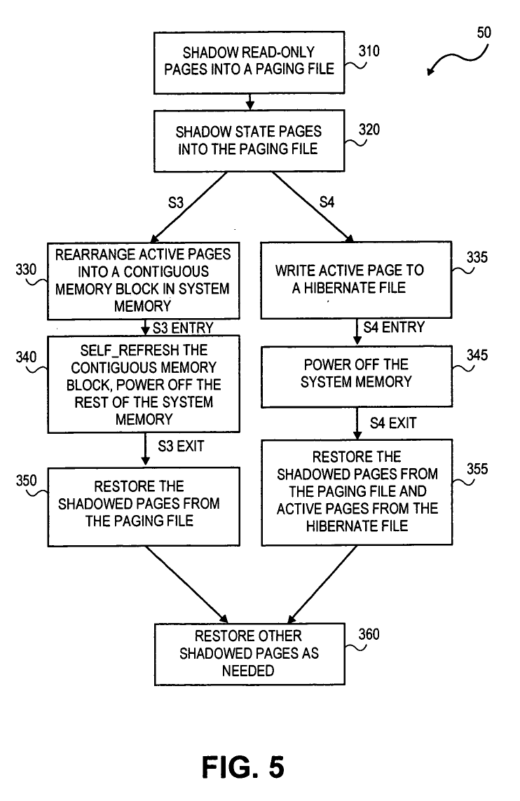

FIG. 5 shows a flowchart 50 of an embodiment of the fine grained power management (FGPM) policy. Although merely the S3, S4, M2_SLP, and M2_OFF states will be described, the FGPM policy is equally applicable to the transitions among all the other Mx states. Also the description below relating to the S3 state is equally applicable to other system low power states (e.g., S1 or S2).

Referring to FIGS. 5, 6, and 7, at block 310, the shadowing component 253 shadows some of the pages in the system memory 201 into a paging file 500 during the active state 301 in preparation for the computing system 20 to sleep. The shadowing operation includes writing the pages into the paging file 500 while continuing to maintain these pages in the system memory 201. These pages are called “shadowed pages” which may include memory pages from either a paged or non-paged memory pool. The paging file 500 is located in the secondary memory 202, or any non-volatile storage such as a hard disk drive, to save the contents of the pages when the system memory 201 or a portion thereof is powered off. In one embodiment, the memory pages that are shadowed at this time are read-only pages.

The shadowing operation described at block 310 is distinctly different from page swapping operation implemented in a virtual memory scheme. Typically, in a virtual memory scheme, an operating system swaps a page by writing the contents of physical memory (e.g., the system memory 201) page into a disk merely when the physical memory is exhausted or during the course of other performance-oriented memory management. Thus, a swapped page is removed from the physical memory to make room for active data. Unlike swapping, the shadowing operation preserves the contents of the page in the physical memory. If not managed properly, the process of shadowing the physical memory could result in a net increase of memory and disk usage, and thus higher overall system power consumption and lower performance. Thus, the shadowing operations may be performed when it is convenient and power-efficient to do so. For example, logic in the shadowing component 253 is configured to allow the shadowing operation to take place immediately after another disk operation is complete to avoid spinning up an idle disk unnecessarily.

At block 320, the shadowing component 253 progressively shadows the pages in the system memory 201 as these pages become stale. A page becomes stale when it is not currently in use or has not been used for a predetermined period of time. Stale pages may include memory pages from a paged or non-paged memory pool. Similar to the shadowing operation of block 310, the stale pages may be shadowed when doing so is convenient and power-efficient. In one embodiment, stale pages include read-only pages and may be shadowed at the same opportune times.

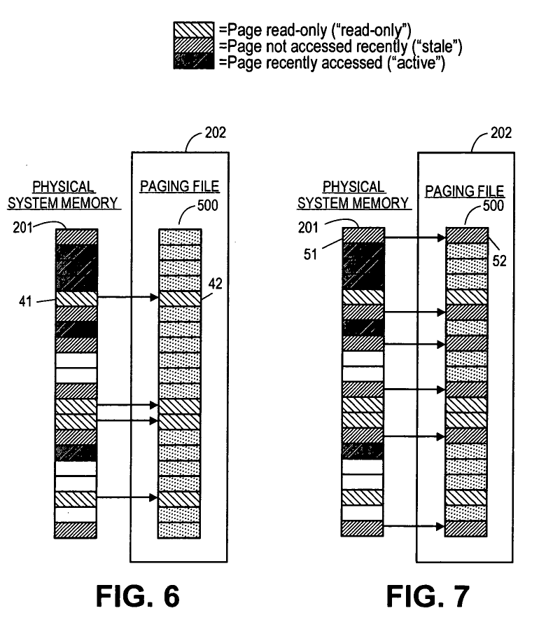

FIG. 6 and FIG. 7 show an example of the shadowing operations performed at blocks 310 and 320. FIG. 6 shows that the system memory 201 includes a plurality of read-only pages, e.g., a page 41. The page 41 is being shadowed into a location 42 in the paging file 500. For the purpose of illustration, the relative positions of the shadowed pages in the paging file 500 are the same as their counterparts in the system memory 201. In alternative embodiments, the pages may be shadowed into any locations in the paging file 500. Similarly, FIG. 7 shows the progressive shadowing of stale pages in the system memory 201, e.g., a stale page 51 is shadowed into a location 52 in the paging file 500.

In one embodiment, a data structure is maintained in a virtual memory manager of the operating system to indicate whether a page in the system memory 201 has been shadowed and where the shadowed location is in the secondary memory 202. For example, a pointer structure including a plurality of pointers may be maintained. Each of the pointers may be assigned to each page in the system memory 201 to link the page with the shadowed location in the paging file 500. A reverse pointer may also be created for the shadowed page in the paging file 500 to point to the counterpart in the system memory 201. The pointers may serve as a flag to indicate whether a system memory page has been shadowed. For example, a NULL pointer for a system memory page may indicate that the page has not been shadowed. In alternative embodiments, the shadow information of a system memory page may be stored as part of a low-level (e.g., firmware or hardware) memory manager transparent to the operating system memory manager.

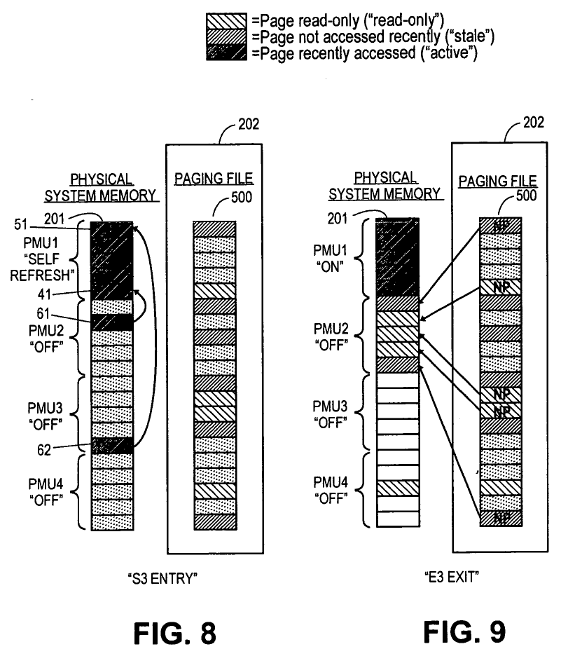

Referring to FIG. 5 and FIG. 8, at block 330, the system memory 201 is placed into a low power state, e.g., the M2_SLP state when the computing system 20 enters the S3 state. Immediately before entering the S3 state, the rearranging component 254 rearranges active pages (e.g., pages that are not stale) into a contiguous memory block. The rearrangement may include relocation, compression, and reordering. It is noted that the shadowing operations at blocks 310 and 320 minimize the working set (the number of active memory pages residing in physical memory) during the S3 entry, and thus reduces the number of physical elements that must remain in the M2_SLP state while the system resides in the S3 state.

After the rearrangement, some of the shadowed pages may be overwritten. For example, an active page 61 overwrites the read-only page 41, and an active page 62 overwrites the stale page 51. Since the pages 41 and 51 have been shadowed into the paging file 500 during the active state 301, these pages do not need to remain in the system memory 201. Throughout the process of memory state transitions, the memory manager 25 continually keeps track of physical memory pages and shadowed pages in the paging file 500. The association between the physical memory pages and pages in the paging file 500 is not required in typical virtual memory management where a page normally resides either in the physical memory 201 or in the paging file 500, but not both. For example, the memory manager 25 may update the pointers and the reverse pointers associated with the overwritten pages 41 and 51 to indicate that the physical locations occupied by the pages 61 and 62 are not associated with the locations 42 and 52 in the paging file 500.

As shown in FIGS. 8-11, the system memory 201 includes four power management units: a PMU1, a PMU2, a PMU3, and a PMU4, each of which may be independently power managed. After the rearrangement at block 340, merely the PMU1 stores the pages that have not been shadowed. Since the shadowed pages do not need to remain in the system memory 201, the power-off unit 257 turns off the power of the PMU2, the PMU3, and the PMU4 to save power. As the contents stored in the PMU2, the PMU3, and the PMU4 have been shadowed during the active state 301 before the S3 entry, the time required for the S3 entry is shortened. At block 340, the PMU1 is self-refreshed to keep the contents alive.

Referring to FIG. 5 and FIG. 9, at block 350, the system memory 201 recovers from the M2_SLP state when the computing system 20 exits from the S3 state. At the time of the S3 exit, the data restoring component 255 merely restores the shadowed non-paged entries not preserved in the system memory 201. Other pages that were previously shadowed (prior to the S3 entry) are restored to the system memory 201 as needed; e.g., upon first access.

This partial restoration of shadowed pages facilitates run-time memory management. As the other shadowed pages had somewhat-aged (e.g. stale) prior to the S3 entry, their presence in the system memory 201 is not necessary until needed. It is noted that normal virtual memory management would not swap these somewhat-aged pages out of the system memory 201 (e.g. because physical memory space had not become exhausted). As physical memory sizes increase, stale pages existing in physical memory 201 becomes more common and incurs unnecessary power consumption. A power/latency tradeoff exists for the number of pages to shadow before the S3 entry and the number of pages to restore at the S3 exit. Although shadowing the pages tends to speed up the S3 entry and reduce the power consumption in the low power state, restoring the shadowed pages tends to slow down the S3 exit. The balance of power and latency may be adjusted to optimize the tradeoff. The “balance” may be achieved by a policy more accurately predicting what pages will be accessed upon resume, and then maintaining these pages in the physical system memory 201 during the M2_SLP/S3 state.

In one embodiment, the data restoring component 255 does not necessarily restore the shadowed pages to the original locations in the system memory 201 at the S3 exit. In the example as shown in FIG. 9, the shadowed pages are returned to a contiguous block of the system memory 201 (e.g., the PMU2). Thus, at the S3 exit, the power-on unit 256 turns on the power of the PMU1 and the PMU2. In addition to save power, restoring the shadowed pages to a contiguous memory block has the advantage of defragmentation of the system memory 201. Defragmentation is a well-known technique in the art of computing for easing the task of memory allocation by the OS.

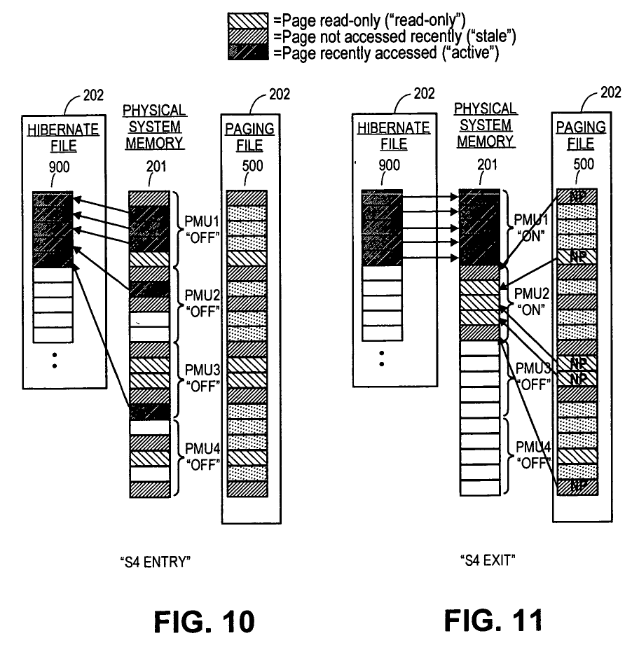

Referring FIG. 5 and FIG. 10, the power manager 252 may command the system memory 201 to enter the M2_OFF (or M3) state when the computing system 20 is about to enter the S4 state. After the shadowing operations performed at blocks 310 and 320, at block 335, the rearranging component 254 relocates active pages in the system memory 201 by writing the active pages into a hibernate file 900 in the secondary memory 202. As all other pages in the system memory 201 have been shadowed into the paging file 500, the working set (i.e., entries needing to be written to the hibernate file 900) is minimized during the S4 entry. At block 345, the power-off unit 257 turns off the power of all of the four PMUs to save power. Here, shadowing during the active state 301 speeds up the S4 entry as merely a fractional portion of the system memory 201 (the active pages) needs to be copied to the hibernate file 900 at the S4 entry.

FIG. 5 and FIG. 11 show the operation performed at the S4 exit. At block 355, the system memory 201 recovers from the M2_OFF (or M3) state when the computing system 20 exists from the S4 state. The data restoring component 255 merely restores the active pages from the hibernate file 900 and the shadowed non-paged entries from the paging file 500 back to a contiguous region of the system memory 201. Similarly to the S3 exit, the power-on unit 256 turns on merely the PMUs containing the restored data. Other shadowed pages are restored as needed at block 360.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
shadowing data from a fractional portion of system volatile memory to system nonvolatile memory during an active state;
rearranging active data in the system volatile memory prior to entering a power-saving mode; and
powering off the system volatile memory containing the shadowed data to enter the power-saving mode.

2. The method of claim 1 further comprising:
restoring a fractional portion of the shadowed data from the system nonvolatile memory into a second region of the system volatile memory upon exiting the power-saving mode; and
powering on the second region.

3. The method of claim 1 wherein the shadowing further comprises:
shadowing a page not currently in use to a device of the system nonvolatile memory when the device is accessed for another active operation.

4. The method of claim 1 wherein the rearranging further comprises:
compressing the active data into a first region of the system volatile memory; and
self-refreshing contents in the first region.

5. The method of claim 1 wherein the powering off comprises:
removing power from one or more power management units (PMUs) of the system volatile memory, wherein each of the PMUs is of a size less than the size a memory chip of the system volatile memory.

6. A method comprising:
specifying more than one memory states for a plurality of power management units (PMUs) in system volatile memory, wherein each of the PMUs is of a size less than the size a memory chip of the system volatile memory; and
independently managing power for each of the PMUs according to the specified memory states.

7. The method of claim 6 wherein managing the power further comprises:
shadowing data from a fractional portion of the system volatile memory to system nonvolatile memory during an active state of the memory states;
rearranging active data in the system volatile memory prior to entering a power-saving mode of the memory states; and
powering off the PMUs containing the shadowed data.

8. The method of claim 7 further comprising:
restoring a fractional portion of the shadowed data into a second region of the system volatile memory upon exiting the power-saving mode; and
powering on the PMUs containing the second region.

9. The method of claim 7 wherein the shadowing further comprises:
shadowing a page not currently in use to a device of the system nonvolatile memory when the device is accessed for another active operation.

10. The method of claim 7 wherein the rearranging further comprises:
compressing the active data into a first region of the system volatile memory; and
self-refreshing the contents of PMUs containing the first region.

11. An apparatus comprising:
a memory state manager to specify more than one memory states for a plurality of power management units (PMUs) in system volatile memory, wherein each of the PMUs is of a size less than the size a memory chip of the system volatile memory; and
a power manager to independently manage power for each of the PMUs according to the specified memory states.

12. The apparatus of claim 11 wherein the power manager comprises:
a shadowing component to shadow data from a fractional portion of the system volatile memory to system nonvolatile memory during an active state of the memory states;
a rearranging component to rearrange active data prior to entering a power-saving mode of the memory states; and
a power-off unit to turn off power of the PMUs containing the shadowed data.

13. The apparatus of claim 11 wherein the power manager comprises:
a data restoring component to restore a fractional portion of the shadowed data into a second region of the system volatile memory upon exiting the power-saving mode; and
a power-on unit to turn on power of the PMUs containing the second region.

14. The apparatus of claim 12 wherein the shadowing component is to shadow a page not currently in use to a device of the system nonvolatile memory when the device is accessed for another active operation.

15. The apparatus of claim 12 wherein the rearranging component is to compress the active data into a first region of the system volatile memory before the PMUs containing the first region are self-refreshed.

16. A system comprising:
a memory state manager to specify more than one memory states for a plurality of power management units (PMUs) in system volatile memory, wherein each of the PMUs is of a size less than the size a memory chip of the system volatile memory;
a power manager to independently manage power for each of the PMUs according to the specified memory states; and
a battery to supply power to the memory state manager and the power manager.

17. The system of claim 16 wherein the power manager comprises:
a shadowing component to shadow data from a fractional portion of the system volatile memory to system nonvolatile memory during an active state of the memory states;
a rearranging component to rearrange active data prior to entering a power-saving mode of the memory states; and
a power-off unit to turn off power of the PMUs containing the shadowed data.

18. The system of claim 16 wherein the power managing component comprises:
a data restoring component to restore a fractional portion of the shadowed data into a second region of the system volatile memory upon exiting the power-saving mode; and
a power-on unit to turn on power of the PMUs containing the second region.

19. The system of claim 17 wherein the shadowing component is to shadow a page not currently in use to a device of the system nonvolatile memory when the device is accessed for another active operation.

20. The system of claim 17 wherein the rearranging component is to compress the active data into a first region of the system volatile memory before the PMUs containing the first region are self-refreshed.

21. A machine-readable medium that provides instructions that, if executed by a machine, will cause the machine to perform operations comprising:
specifying more than one memory states for a plurality of power management units (PMUs) in system volatile memory, wherein each of the PMUs is of a size less than the size a memory chip of the system volatile memory; and
independently managing power for each of the PMUs according to the specified memory states.

22. The machine-readable medium of claim 21, if executed by a machine, will cause the machine to perform operations further comprising:
shadowing data from a fractional portion of the system volatile memory to system nonvolatile memory during an active state of the memory states;
rearranging active data in the system volatile memory prior to entering a power-saving mode of the memory states; and
powering off the PMUs containing the shadowed data.

23. The machine-readable medium of claim 21, if executed by a machine, will cause the machine to perform operations further comprising:
restoring a fractional portion of the shadowed data into a second region of the system volatile memory upon exiting the power-saving mode; and
powering on the PMUs containing the second region.
